(19) United States
(12) Patent Application Publication
(10) Pub. No.: US 2011/0013566 A1
(43) Pub. Date: Jan. 20, 2011

(54) COMMUNICATION METHOD, COMMUNICATION SYSTEM, MOBILE NODE, ACCESS ROUTER

(75) Inventors: Keigo Aso, Osaka (JP); Chun Keong Benjamin Lim, Singapore (SG); Chan Wah Ng, Singapore (SG); Tien Ming Benjamin Koh, Singapore (SG)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/922,835

(22) PCT Filed: Mar. 10, 2009
(86) PCT No.: PCT/JP2009/001074

§ 371 Date: Oct. 5, 2010

(30) Foreign Application Priority Data
Mar. 17, 2008 (JP) 2008-068333

(51) Int. Cl. H04W 8/02

(52) U.S. Cl. 370/328

(57) ABSTRACT

Disclosed is a technique to reduce the number of messages to register mobile node position information with a home agent when a mobile node roams into a foreign network domain having a roaming relationship with a home network domain. Upon reception of network information 40, when the network information 40 contains a foreign prefix, a MN 11 creates a care-of address (CoA) using the foreign prefix (Step S44). The MN 11 further checks whether the network information 40 contains a home prefix (Step S45). When no home prefix is included in the prefix 203, a BU message is transmitted to a home MAP 1000 (Step S46). When a home prefix exists in the prefix 203, the BU message is not transmitted to the home MAP 1000 (Step S47).

### TECHNICAL FIELD

The present invention relates to a communication method, a communication system, a mobile node and an access router when a mobile node roams into a foreign network domain from a home network domain.

### BACKGROUND ART

According to mobile IPv6 (MIPv6) in the following Non-Patent Document 1, a mobile node (MN) can keep one Internet protocol (IP) address permanently even when its connection point with the Internet is changed. This permanent IP address in MIPv6 is an address within a home network domain of the mobile node, known as a home address. When connected with a foreign network domain, the mobile node can configure an IP address to be used in the foreign network domain from a prefix advertised from the foreign network domain. Such a configured IP address is called a care-of address, which can be used as a destination for the mobile node.

In order to keep the reachability irrespective of the location, the mobile node binds the care-of address to the home address with its home agent. The home agent in MIPv6 is a router or a host in the home network with which the current care-of address of the mobile node is registered. This binding can be implemented by the mobile node that transmits a binding update (BU) message to the home agent. When the mobile node moves from the home network to the outside, the home agent intercepts a packet addressed to the home address of the mobile node and tunnels the packet to the care-of address. According to MIPv6, a host is included in a mobility management domain. Thus, MIPv6 is known as a host-based mobility management protocol.

In another form of mobility management, a mobile node is not required to perform mobility management signaling when the mobile node roams within the mobility domain. In this form, as described in the following Non-Patent Document 2, a proxy entity in the mobility domain helps the mobility management for the mobile node. Such mobility management is called network-based mobility management.

When the mobile node moves within a mobility domain, the mobile node presents its own identifier (MN-ID) to a proxy entity (known as a mobile access gateway (MAG)) as a part of access authentication procedure. This MN-ID is typically used for association with a policy profile of the mobile node available from a local server. The policy profile of the mobile node contains characteristics of a network-based mobility service, other related parameters, e.g., a network prefix (MN.Home.Prefix) assigned to the mobile node, a permitted address configuration mode, a roaming policy, and other parameters essential to provide a network-based mobility service.

After access authentication of the mobile node succeeds, the mobile access gateway (MAG) acting as a proxy entity, acquires the policy profile of the mobile node from the local server. This means that the mobile access gateway has all information necessary to execute a mobility service for the mobile node. Thus, the mobile access gateway periodically transmits a router advertisement message to advertise a network prefix (MN.Home.Prefix) to the mobile node. When the mobile node sees the network prefix (MN.Home.Prefix), the mobile node configures an IP address (home address) of its own interface connected with the mobility domain. When a mobile node roams within a mobility domain, an interface connected with the mobility domain always sees the network prefix (MN.Home.Prefix). This can be implemented because the mobile access gateway connected with the mobile node always accesses the local server to acquire a profile of the mobile node. Therefore, irrespective of the location of the mobile node in the mobility domain, the mobile node can always use the IP address that was initially configured by the mobile node.

An entity called a local mobility anchor (LMA) operates as a geographic anchor point of each mobile node in the mobility domain. In the following description, this may be called a mobility anchor point (MAP) as well. In addition, the local mobility anchor further manages the reachability of each mobile node. Therefore, the local mobility anchor has a certain similarity to the home agent described in Non-Patent Document 1. In order to serve as the anchor point for each mobile node, the local mobility anchor has to be updated regarding the current location of each mobile node. Thus, when the mobile node is connected with the mobile access gateway, the mobile access gateway always transmits a proxy BU message to the local mobility anchor so as to bind the network prefix (MN.Home.Prefix) to the care-of address of the mobile access gateway. This binding allows the local mobility anchor to route a packet addressed to the mobile node via an appropriate mobile access gateway. As still other conventional techniques, the following Patent Documents 1 and 2 are known.

Non-Patent Document 1: D. Johnson, C. Perkins and J. Arkko, “Mobility Support in IPv6”, Internet Engineering Task Force Request For Comments 3775, June 2004.

Non-Patent Document 2: S. Gundavelli, K. Leung, V. Devarapalli, K. Chowdhury and B. Path, “Proxy Mobile IPv6”, Internet Engineering Task Force Internet Draft: draft-ietf-netlmm-proxymip6-00.txt, Apr. 8, 2007.

Patent Document 1: V. Magret and L. Rose, “Simple multicast extension for mobile IP SMM”, U.S. Pat. No. 6,988,146, Jan. 17, 2006.

Patent Document 2: M-S. Do, Y-H. Han, H-J. Jang and J-H. Bang, “Method of configuring and registering Internet protocol address in a wireless mobile communication system having connection-oriented radio link”, US Patent Application Publication Number US2007/0091822A1, Apr. 26, 2007.

The following describes a problem occurring when a mobile node roams from a home network domain to a foreign network domain. FIG. 10 illustrates an exemplary network-based mobility management system. In a state of FIG. 10, a mobile node (MN) 11a is connected with a correspondent node (CN) 12 via a domain 100 (i.e., home network domain) to which the mobile node 11a belongs and the Internet 102, and a MN 11b roams into a domain 101 (i.e., a foreign network domain) to which the mobile node 11b does not belong so as to be connected with the CN 12 via the foreign network domain 101 and the Internet 102.

In this example, the home network domain 100 and the foreign network domain 101 are cellular operators, for example, between which a roaming contract is exchanged, and both of the domains are PMIP domains. A local mobility anchor (LMA/HA1) in the home network domain 100 is a home agent (HA) for the MN 11a, and a mobile access gateway (MAG1) is a proxy node for the MN 11a. The MN 11a in the home network domain 100 creates a home address (HoA) from a home prefix advertised from the MAG1 for a communication with the CN 12.

A MAG2 serving as a proxy node for the MN 11b in the foreign network domain 101 exchanging a roaming contract with the home network domain 100 can acquire information (e.g., a home prefix, and an address of LMA/HA1) on the MNs 11a and 11b from a local server (LS1) in the home network domain 100. Thus, the MAG2 in the foreign network domain 101 advertises a prefix (home prefix) of the home network domain 100 and its own prefix (foreign prefix). In order to allow the MN 11b under the control of the foreign network domain 101 to establish a communication with the ON 12 by using both of the home address (HoA) and a care-of address (CoA) created from the foreign prefix, registration (binding) of the care-of addresses of the MN 11b and the MAG2 to the home address (HoA) of the MN 11a has to be conducted with the LMA/HA1 on the home network domain 100 side. Herein, the MN 11b has to communicate with the CN 12 by using both of the home address (HoA) and the care-of address (CoA) when only one of the addresses cannot achieve an end-to-end quality of service (E2E QoS).

FIG. 11 illustrates the procedure for registration.

1. To begin with, the MAG2 in the foreign network domain 101 transmits a proxy BU (PBU) message to the LMA/HA1, thus binding its own care-of address (MAG.CoA) to the home address (HoA) of the MN 11a in a binding cache entry (BCE) of the LA/HA1.

2. The MN 11b roaming into the foreign network domain 101 transmits a BU message to the LMA/HA1, thus binding its own care-of address (MN.CoA) to the home address (HoA) of the MN 11a in the binding cache entry (BCE).

In the above-stated procedure, however, the care-of address (MN.CoA) of the MN 11b is created from the foreign prefix advertised by the MAG2. Thus, position information registered by the BU message, which is transmitted by the MN 11b to the LMA/HA1, indicates that the MN 11a can reach via the MAG2, showing the same path as in the position information registered by the PBU message. Therefore, one of these messages will be redundant.

Patent Document 1 as a conventional technique describes a method in which a mobile node makes a request for a multicast address to a mobile anchor point using a BU message. Patent Document 1 proposes letting a BU message transmitted from a mobile node to a mobile anchor point have a certain meaning. Patent Document 1 further describes a method used for multicast discovery (e.g., multicast source discovery protocol) that does not require a multicast support request in a BU message.

As another conventional technique, Patent Document 2 describes a method in which an access router registers a care-of address of a mobile node with a mobile anchor point as a home agent of the mobile node. In Patent Document 2, the access router and the mobile node create the same care-of address separately, and both of the access router and the mobile node have a unique connection identifier (CID), a MAC address of the mobile node, and a prefix to calculate a care-of address. Since an input for calculation is unique, the access router and the mobile node can reach with the same care-of address. Thus, the access router can register, for the mobile node, the care-of address of the mobile node with the mobile anchor point as the home agent of the mobile node. With this method, the mobile node doesn't have to transmit a BU message to the home agent.

### DISCLOSURE OF THE INVENTION

In view of the above-stated problems of the conventional techniques, it is an object of the present invention to provide a communication method, a communication system, a mobile node, and an access router of a foreign network domain by which, when a mobile node roams into a foreign network domain having a roaming relationship with a home network domain, the number of messages to register position information on the mobile node with the home agent can be reduced.

To fulfill the above-stated object, when a mobile node roams into a foreign network domain from a home network domain, a communication method of the present invention includes: a step conducted by the foreign network domain of transmitting a foreign prefix as a prefix of the foreign network domain, and when the foreign network domain has a roaming contract relationship with the home network domain, of transmitting a home prefix as a prefix of the home network domain; and a step conducted by the mobile node of receiving the foreign prefix from the foreign network domain and creating, from the foreign prefix, a care-of address to be used in the foreign network domain, while determining whether the home prefix is received or not from the foreign network domain, when the home prefix is not received, transmitting a registration message to a home agent of the home network domain, the registration message registering the created care-of address, and when the home prefix is received, not transmitting the registration message.

To fulfill the above-stated object, when a mobile node roams into a foreign network domain from a home network domain, a communication system of the present invention includes: means that makes the foreign network domain transmit a foreign prefix as a prefix of the foreign network domain, and when the foreign network domain has a roaming contract relationship with the home network domain, transmit a home prefix as a prefix of the home network domain; and means that makes the mobile node receive the foreign prefix from the foreign network domain and create, from the foreign prefix, a care-of address to be used in the foreign network domain, while making the mobile node determine whether the home prefix is received or not from the foreign network domain, when the home prefix is not received, transmit a registration message to a home agent of the home network domain, the registration message registering the created care-of address, and when the home prefix is received, not transmit the registration message.

To fulfill the above-stated object, when a mobile node roams into a foreign network domain from a home network domain, the mobile node in a communication system of the present invention includes: means that receives a foreign prefix as a prefix of the foreign network domain transmitted from the foreign network domain, while receiving a home prefix as a prefix of the home network domain transmitted when the foreign network domain has a roaming contract relationship with the home network domain; means that creates a care-of address to be used in the foreign network domain from the foreign prefix received from the foreign network domain; and binding determination means that determines whether the home prefix is received or not from the foreign network domain, when the home prefix is not received, transmits a registration message to a home agent of the home network domain, the registration message registering the created care-of address, and when the home prefix is received, does not transmit the registration message to the home agent.

When both of the foreign prefix and the home prefix advertised from an access router of the foreign network domain are received, and when the foreign prefix only is to be used, the above-stated binding determination means notifies the access router of not advertising the home prefix and transmits the registration message to the home agent. When the home prefix only is to be used, the binding determination means notifies the access router of not advertising the foreign prefix and does not transmit the registration message to the home agent.

The above-stated binding determination means transmits, to a home agent of the foreign network domain, a message to be notified to the access router of the foreign network domain and makes the home agent of the foreign network domain notify the access router of the message.

The above-stated mobile node further includes: a first interface for a connection with the access router of the foreign network domain; and a second interface for a connection with an access router of the home network domain. The binding determination means transmits a message to be notified to the access router of the foreign network domain to the home agent of the home network domain via the second interface so as to make the home agent of the home network domain notify the access router of the message.

To fulfill the above-stated object, when a mobile node roams into a foreign network domain from a home network domain, a communication method of the present invention includes: a step conducted by an access router of the foreign network domain of transmitting a foreign prefix as a prefix of the foreign network domain, and when the foreign network domain has a roaming contract relationship with the home network domain, of transmitting a home prefix as a prefix of the home network domain; and a step conducted by the access router of the foreign network domain of determining which prefix of the foreign prefix and the home prefix the mobile node uses, when the foreign prefix only is to be used, stopping transmission of the home prefix, and when the home prefix only is to be used, stopping transmission of the foreign prefix.

To fulfill the above-stated object, when a mobile node roams into a foreign network domain from a home network domain, a communication system of the present invention includes: means that makes an access router of the foreign network domain transmit a foreign prefix as a prefix of the foreign network domain, and when the foreign network domain has a roaming contract relationship with the home network domain, transmit a home prefix as a prefix of the home network domain; and means that makes the access router of the foreign network domain determine which prefix of the foreign prefix and the home prefix the mobile node uses, when the foreign prefix only is to be used, stop transmission of the home prefix, and when the home prefix only is to be used, stop transmission of the foreign prefix.

To fulfill the above-stated object, when a mobile node roams into a foreign network domain from a home network domain, an access router in the foreign network domain of the present invention includes: means that transmits a foreign prefix as a prefix of the foreign network domain, and when the foreign network domain has a roaming contract relationship with the home network domain, transmits a home prefix as a prefix of the home network domain; and means that determines which prefix of the foreign prefix and the home prefix the mobile node uses, when the foreign prefix only is to be used, stops transmission of the home prefix, and when the home prefix only is to be used, stops transmission of the foreign prefix.

To fulfill the above-stated object, when a mobile node roams into a foreign network domain from a home network domain, a communication method of the present invention includes: a step conducted by an access router of the foreign network domain of transmitting a foreign prefix as a prefix of the foreign network domain, and when the foreign network domain has a roaming contract relationship with the home network domain, of transmitting a home prefix as a prefix of the home network domain; and a step conducted by the access router of the foreign network domain of determining whether the mobile node uses or not the foreign prefix, and when the foreign prefix is to be used, notifying the mobile node that a registration message is not transmitted to a home agent of the home network domain, the registration message registering the created care-of address.

To fulfill the above-stated object, when a mobile node roams into a foreign network domain from a home network domain, a communication system of the present invention includes: means that makes an access router of the foreign network domain transmit a foreign prefix as a prefix of the foreign network domain, and when the foreign network domain has a roaming contract relationship with the home network domain, transmit a home prefix as a prefix of the home network domain; and means that makes the access router of the foreign network domain determine whether the mobile node uses or not the foreign prefix, and when the foreign prefix is to be used, notify the mobile node that a registration message is not transmitted to a home agent of the home network domain, the registration message registering the created care-of address.

To fulfill the above-stated object, when a mobile node roams into a foreign network domain from a home network domain, an access router in the foreign network domain of the present invention includes: means that transmits a foreign prefix as a prefix of the foreign network domain, and when the foreign network domain has a roaming contract relationship with the home network domain, transmits a home prefix as a prefix of the home network domain; and means that determines whether the mobile node uses or not the foreign prefix, and when the foreign prefix is to be used, notifies the mobile node that a registration message is not transmitted to a home agent of the home network domain, the registration message registering the created care-of address.

When a mobile node roams into a foreign network domain having a roaming relationship with a home network domain, this configuration allows the mobile node not to transmit a message to register position information thereof with a home agent, so that the number of messages can be reduced.

According to the present invention, when a mobile node roams into a foreign network domain having a roaming relationship with a home network domain, the number of messages to register mobile node position information with a home agent can be reduced.

### BRIEF DESCRIPTION OF THE DRAWINGS

FIG. 1 is a block diagram illustrating an exemplary communication system when a mobile node roams into a foreign network domain having a roaming relationship with a home network domain.

FIG. 2 illustrates a format of network information in Embodiment 1.

FIG. 3 is a block diagram illustrating a configuration of a mobile node in Embodiment 1.

FIG. 4 is a flowchart illustrating a binding determination processing by the mobile node in Embodiment 1.

FIG. 5 illustrates a communication sequence in Embodiment 1.

FIG. 6 is a flowchart illustrating a binding determination processing by the mobile node in Embodiment 2.

FIG. 7 illustrates a format of a prefix assignment message in Embodiment 2

FIG. 8 is a block diagram illustrating a communication system in Embodiment 4.

FIG. 9 illustrates a format of network information in Embodiment 6.

FIG. 10 is a block diagram illustrating an exemplary communication system when a mobile node roams into a foreign network domain having a roaming relationship with a home network domain.

FIG. 11 illustrates a problem to be solved by the present invention.

### BEST MODE FOR CARRYING OUT THE INVENTION

The following describes embodiments of the present invention with reference to the drawings.

### Embodiment 1

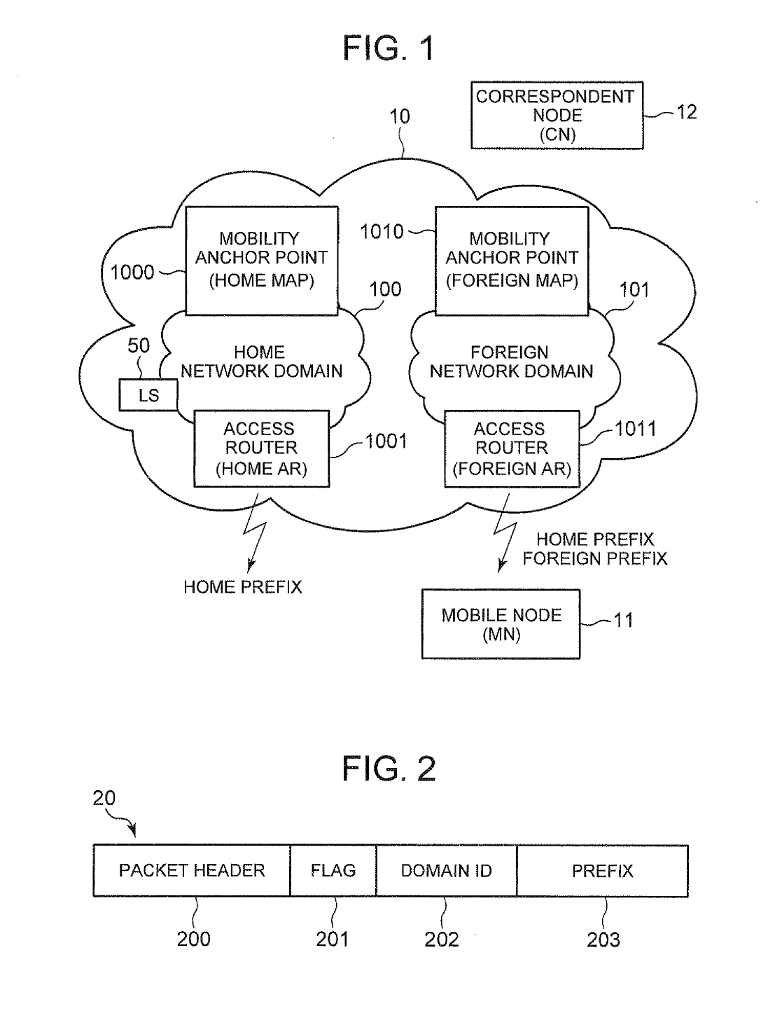

FIG. 1 illustrates an exemplary mobility management system when a mobile node (MN) 11 roams into a foreign network domain 101 having a roaming relationship with a home network domain 100. The MN 11 in FIG. 1 belongs to the home network domain 100. The home network domain 100 and the foreign network domain 101 are cellular operators, for example, between which a roaming contract is exchanged so that the MN 11 belonging to the home network domain 100 can use the foreign network domain 101 (a roaming contract relationship 10 of FIG. 1). Further, both of the domains 100 and 101 are PMIP domains, and are managed by mobility anchor points (MAP) 1000 and 1010, respectively. The MAPs 1000 and 1010 are equipped with a function of a home agent (HA) or a function of a local MAP (LMA), or both of the functions (LMA/HA). Further, access routers (AR) 1001 and 1011 in the domains 100 and 101 function as a connection point of the MN 11, and have a function of a mobile access gateway (MAG). Herein, in a 3GPP network, a home network domain is called a home public land mobile network (HPLMN), and a foreign network domain is called a visited public land mobile network (VPLMN). The MN corresponds to a user equipment (UE), the MAP corresponds to a packet data network gateway (PDN-GW), the access router corresponds to a serving gateway (S-GW), and a LS corresponds to a home subscriber server (HSS) or an authentication authorization and accounting (AAA) server. That is to say, a network managed by a home operator of the UE is a HPLMN and a network managed by another operator into which the UE roams is a VPLMN. Herein, a communication not via a home and by directly using an address acquired from the roaming destination is called local breakout, and a communication via home even after the movement to the roaming destination is called home routed. Although not illustrated, a proxy node (AAA proxy, for example) corresponding to each network node in the home network domain may exist in the foreign network domain. In Embodiment 1 of the present invention, there may be a case where the MN 11 of FIG. 1 is equipped with two interfaces (e.g., a 3GPP interface (IF1) and a WLAN/WIMAX interface (IF2)). When both of the home network domain 100 and the foreign network domain 101 are 3GPP networks, the IF2 carries out a communication (Home Routed) from a Non 3GPP network managed by the foreign network domain 101 via the home network domain 100 or a communication (local breakout) directly from the foreign network domain 101, or both of them.

In the above-stated network configuration, when the MN 11 is connected with an AR 1001 (hereinafter called a home AR) in the home network domain 100 first, the network-based mobility management makes the home AR 1001 transmit a PBU message to the MAP 1000 (hereinafter called a home MAP), and the home MAP 1000 binds a home prefix (MN11.Home.Prefix) of the MN 11 to a care-of address (AR1001.CoA) of the home AR 1001. This operation allows the home MAP 1000 to route a packet for the MN 11 within the home network domain 100.

Next, when the MN 11 roams into the foreign network domain 101, the MN 11 tries association with the AR 1011 (hereinafter called a foreign AR). Since the foreign network domain 101 has a roaming contract relationship 10 with the home network domain 100, the foreign AR 1011 succeeds in authentication of the MN 11, and can acquire a policy profile of the MN 11 from a local server (LS) 50. This policy profile of the MN 11 describes an identifier (e.g., IP address) of the current MAP for the MN 11. In this system, the foreign AR 1011 understands from this policy profile of the MN 11 that the home MAP 1000 is the current MAP for the MN 11. Thus, the foreign AR 1011 transmits a PBU message to the home MAP 1000 so as to bind the home prefix (MN11.Home.Prefix) of the MN 11 to the care-of address (AR1011.CoA) of the foreign AR 1011. This operation updates the home MAP 1000 regarding the current location of the MN 11, whereby the home MAP 1000 can perform routing of a packet addressed to the MN 11. Herein, when configuring the association with the AR 1011, the MN 11 may transmit, to the AR 1011, a service name (Access Point Name) connected before the movement and information (Identity, address, and FQDN of the MAP 1000) enabling identification of the MAP 1000 managing the movement and a network thereof, and may make a notification of information indicating that the MN 11 wants to continue a connection with the MAP and the network specified by the notified information even after handover to a network where the MN 11 roams (Home Routed). Alternatively, the MN 11 may directly acquire an address from the foreign network domain 101 and make a notification of information indicating that the MN 11 wants a communication (Local Breakout). The information requesting Local Breakout may be notified together with the information requiring Home Routed.

The policy of the roaming contract exchanged between the home network domain 100 and the foreign network domain 101 limits a type of a service provided to the MN 11. For instance, since the MN 11 knows the existence of the foreign network domain 101, the MN 11 can associate with a plurality of foreign MAPs 1010 in the foreign network domain 101. To advertise that an MAP 1010 is available, the MAP 1010 instructs the AR 1011 to advertise a prefix different from that of the home network domain 100. Thus, when the MN 11 roams in the foreign network domain 101 having the roaming contract relationship 10 with the home network domain 100, there is a high possibility that the MN 11 acquires a lot of prefixes. One of these prefixes reflects the home network domain 100, and others indicate, to the MN 11, the existence of other foreign MAPs 1010 having the roaming contract relationship 10.

The following describes an example assumed in detail. In FIG. 1, according to the policy for the MN 11, when the MN 11 roams in the foreign network domain 101 having the roaming contract relationship 10, the MN 11 is notified about a MAP 1010 (foreign MAP) of the domain 101. Thus, the foreign MAP 1010 assigns a local prefix of the foreign network domain 101 to the MN 11. The MN 11 regards this local prefix as a foreign prefix that is not a part of a home prefix assigned by the MAP 1000. Further the AR 1011 advertises, to the MN 11, both of the home prefix and the foreign prefix. Thus, the MN 11 knows another MAP 1010 in the foreign network domain 101 having the roaming contract relationship 10.

A foreign prefix being available means that the MN 11 has a chance to use such a foreign prefix. The MN 11 may use a foreign prefix because, even when it has a home prefix, the foreign network domain 101 having the roaming contract relationship 10 therewith may provide a different QoS level depending on the location of the MN 11. This implies that the MN 11 configures a care-of address from the foreign prefix based on a QoS level decided between the MN 11 and the CN 12. Then, the MN 11 will bind such a care-of address with the home MAP 1000 of the home network domain 100.

In another case, the MN 11 may use a foreign prefix depending on a mobility management function that the MN 11 has, even when it has a home prefix. As described above, the mobility management function includes two types of host base and network base. Such mobility management functions are equipped in a mutually independent manner, and are uniquely triggered. Thus, according to a host-based mobility management function, when receiving a foreign prefix, the MN 11 configures a care-of address and transmits a BU message to a home MAP 1000 of the home network domain 100 for binding of the care-of address.

The following describes the above-stated mobility management function triggered by the MN 11 in detail. In FIG. 1, firstly the MN 11 configures a care-of address (MN11.CoA) from a foreign prefix (MN11.Foreign.Prefix). Next, the MN 11 transmits, to the MAP 1000, a BU message to bind the care-of address (MN11.CoA) to the home address (MN11.HoA) of the MN 11. Thus, the MAP 1000 knows that the MN 11 can reach with the care-of address (MN11.CoA). When routing a packet addressed to the MN 11, the MAP 1000 can use the care-of address (MN11.CoA) as a proxy routing path.

According to the above-stated example, it is understood that the home MAP 1000 is notified from both of the MN 11 and the foreign AR 1011 about how to route a packet addressed to the MN 11. That is, the foreign AR 1011 notifies the home MAP 1000 using a PBU message that the MN 11 can reach via the foreign AR 1011, and the MN 11 notifies the home MAP 1000 using a BU message that the MN 11 can reach via the foreign AR 1011. This implies that both of the messages (PBU, BU messages) convey the same meaning (that the MN 11 can reach via the foreign AR 1011) to the home MAP 1000. Thus, it can be understood that the BU or the PBU message is redundant for the home MAP 1000. As one example, before the MN 11 transmits the BU message, the foreign AR 1011 may transmit the PBU message. In this case, the BU message will be redundant for the home MAP 1000.

Further, when the MN 11 sets a filtering rule in the home MAP 1000 so that an input packet is routed to the care-of address (MN11.CoA), such a packet will reach the foreign AR 1011 via the foreign MAP 1010. In this case, since the foreign MAP 1010 provides the prefix used to configure the care-of address (MN11.CoA), the foreign MAP 1010 intercepts a packet addressed to the care-of address (MN11.CoA) and routes the same to the MN 11 via the foreign AR 1011. Thus, a delay will increase in packet reception at the MN 11 although re-routing enables direct routing from the home MAP 1000 to the foreign AR 1011.

<Outline of the Present Invention>

The present invention provides a method to allow the MN 11 under a specific condition to prevent redundant registration of a care-of address with a mobility anchor point (hereinafter called a home MAP) 1000 as a home agent of the home network domain 100. This method is especially effective for the case where the foreign AR 1011 already has another means to configure a routing path from the MN 11 to the home MAP 1000. This method requires the MN 11 firstly receiving information from a network currently associating therewith. Based on this received information, the MN 11 can determine whether or not to notify the home MAP 1000 of a care-of address to be used. For instance, when the home MAP 1000 already knows a care-of address, the MN 11 will not make a notification of a care-of address. Not making a notification can prevent redundant signaling between the MN 11 and the home MAP 1000.

<Network Information>

For the above-stated determination, the MN 11 needs some pieces of related network information. This network information is advertised to the MN 11 via a foreign AR 1011 associating with the MN 11, which is transmitted with a router advertisement message or a neighbor solicitation message as well as with a beacon of IEEE802.11, layer 2 signaling used in a cellular system such as a 3GPP, signaling exchanged during the attach procedure to a 3GPP network, an information service response message to IEEE802.21, for example. Herein, the UE may transmit a router solicitation message to the AR 1011 so as to receive the router advertisement message including the network information.

FIG. 2 illustrates a format of network information 20 that the MN 11 receives from a domain (e.g., foreign network domain 101) having the roaming contract relationship 10 with the home network domain 100. The network information 20 is made up of fields of: a packet header 200; a network based mobility support flag 201; a domain ID 202; and a prefix 203. The packet header 200 is made up of: a message sender configured with an address of IPv4 or IPv6; a type field indicating a message type; and a message length field.

The network based mobility support flag 201 indicates whether the network with which the MN 11 currently associates can support a network-based mobility function or not. The flag 201 may be one bit where ‘1’ indicates “supporting a network-based mobility function” and ‘0’ indicates “not supporting a network-based mobility function”. In the case of the flag 201=0, the MN 11 executes a certain mobility management function to maintain the connectivity with the home MAP 1000.

The domain ID 202 preferably is made up of a cellular operator name or a service set identifier (SSID) of a WLAN hotspot. The domain ID 202 is aimed to provide the MN 11 with a network name with which the MN 11 currently associates. When knowing this network name, the MN 11 can execute some checks to determine whether the network is located or not in a domain having the roaming contract relationship 10. One method therefor is that the MN 11 makes an inquiry to the home MAP 1000 as to whether the domain ID 202 has the roaming contract relationship 10 or not.

The prefix 203 indicates one or a plurality of prefixes that the MN 11 can use. In the present embodiment, the prefix 203 preferably includes a home prefix and a foreign prefix. The home prefix is assigned to the MN 11 from the home MAP 1000, and the routing of the home prefix is dealt with by the home MAP 1000 that is an anchor point of the home network domain 100. Similarly, the foreign prefix is assigned to the MN 11 from the foreign network domain 101, and the routing of the foreign prefix is dealt with by the foreign MAP 1010 that is an anchor point of the foreign network domain 101.

Note that although FIG. 2 illustrates a preferable format of the network information, it would be obvious for those skilled in the art that the information of the network with which the MN 11 associates can be variously modified. For instance, when the foreign network domain 101 does not support network-based mobility for the MN 11, the prefix 203 in the network information 20 has only one foreign prefix. In this case, the MN 11 has to transmit a BU message to bind a care-of address (MN11.CoA) configured from the foreign prefix with the home MAP 1000.

<Functional Configuration of MN>

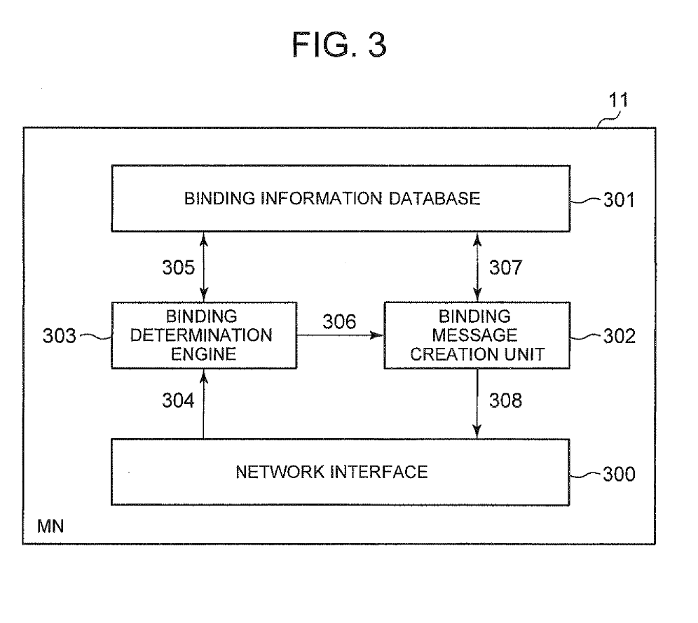

FIG. 3 illustrates a functional configuration of the MN 11 including: a network interface 300; a binding information database 301; a binding message creation unit 302; and a binding determination engine 303. The network interface 300 is a functional block having hardware and software allowing the MN 11 to establish a communication with other nodes via a certain communication medium. Using known terms in the related technical field, the network interface 300 represents a communication component of layer 1 (physical layer) and layer 2 (data link layer), firmware, a driver, and a profile. It would be obvious for those skilled in the art that the MN 11 may include one or a plurality of network interfaces 300. A trigger signal and a packet can be exchanged between the network interface 300 and the binding determination engine 303 via a signal/data path 304. For instance, network information 20 received by the network interface 300 is transmitted to the binding determination engine 303 via the signal/data path 304, whereby the binding determination engine 303 can execute action. The action of the binding determination engine 303 will be described later.

The binding information database 301 stores information necessary for the MN 11. In the present embodiment, the database 301 stores a home prefix of the MN 11 and a security association key between the MN 11 and the home MAP 1000. A trigger signal and a packet can be exchanged between the database 301 and the binding determination engine 303 via a signal/data path 305. For instance, the binding determination engine 303 can use the signal/data path 305 to extract the home prefix of the MN 11 from the database 301. Similarly, a trigger signal and a packet can be exchanged between the database 301 and the binding message creation unit 302 via a signal/data path 307. For instance, the binding message creation unit 302 can extract from the database 301a security association key to authorize a BU message via the signal/data path 307.

Further, the binding message creation unit 302 can format a BU message transmitted to the home MAP 1000. Using known terms in the related technical field, the binding message creation unit 302 may be equipped with the same function as in creating a BU message described in Non-Patent Document 1. Herein, when a necessary connection does not exist yet with the MAP 1000, the binding message creation unit 302 executes processing to create a connection with the MAP 1000. For instance, when the home network is a 3GPP network, the binding message creation unit 302 configures a PDN connection with a P-GW (MAP 1000), and also creates Security Association (SA) and the like to protect a BU message. A trigger signal and a packet can be exchanged between the network interface 300 and the binding message creation unit 302 via a signal/data path 308. For instance, a BU message is transmitted from the binding message creation unit 302 to the network interface 300, thus enabling transmission of the same to the home MAP 1000.

In the present embodiment, in order for the binding message creation unit 302 to determine whether or not to update the home MAP 1000 regarding the current location of the MN 11, the binding determination engine 303 is introduced. Based on an input from the network interface 300 and the binding information database 301, the binding determination engine 303 determines whether or not the binding message creation unit 302 has to format a BU message for a specific care-of address. Preferably the binding determination engine 303 checks whether a home prefix as well as a foreign prefix used to configure a care-of address exist or not in the prefix 203. If so, the binding determination engine 303 considers that the AR 1011 deals with both of the foreign prefix and the home prefix and the home MAP 1000 is already updated with the current location of the MN 11. Thus, the binding message creation unit 302 is not triggered with any care-of address configured by the MN 11 using a foreign prefix.

A trigger signal and a packet can be exchanged between the binding determination engine 303 and the binding message creation unit 302 via a signal/data path 306. For instance, the binding determination engine 303 can use the signal/data path 306 to request the binding message creation unit 302 to create a BU message for a specific care-of address.

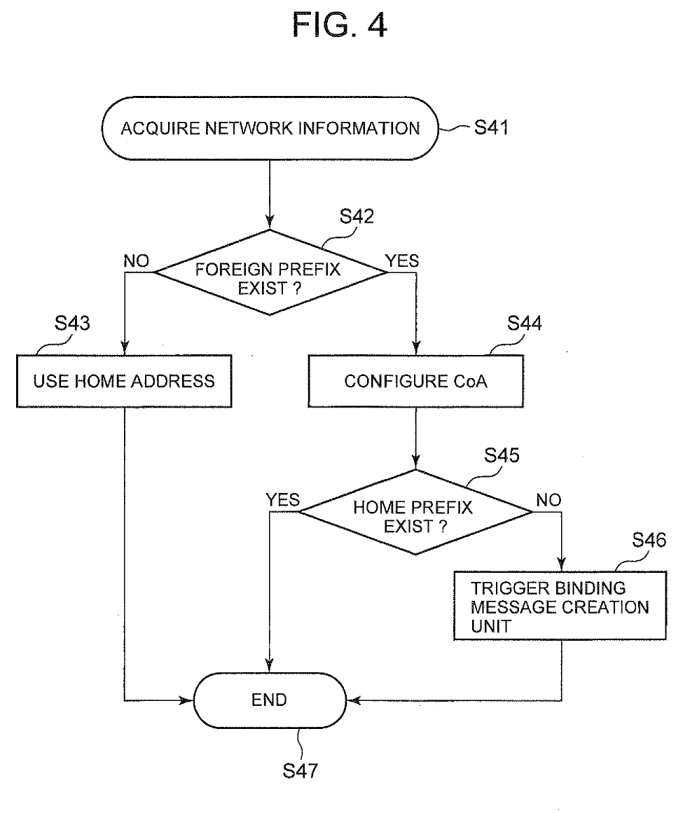

The following describes the processing by the MN 11 to implement Embodiment 1. FIG. 4 is a flowchart illustrating a binding determination processing by the MN 11. This processing starts when the binding determination engine 303 receives network information 40 (Step S41). Herein, if possible, the network information 40 can be acquired from an access router with a router advertisement message, for example. When the processing starts from Step S41, the binding determination engine 303 checks whether a foreign prefix exists or not in the prefix 203 of the network information 40 (Step S42). Absence of a foreign prefix implies that a home prefix only exists in the prefix 203. When the foreign prefix does not exist, a network-based mobility management function is triggered, the home address is assigned to the interface 300 of the MN 11, the interface 300 uses this home address (Step S43), and then this processing is finished (Step S47).

On the other hand, when the prefix 203 includes a foreign prefix at Step 842, a care-of address (CoA) is created for the interface 300 using this foreign prefix (Step S44). Herein, a CoA refers to an address associated with the home address. In this case, however, the CoA is a global address as well that is used for local breakout. The binding determination engine 303 preferably knows a policy that the MN 11 prefers to use the care-of address if possible. Next, after assigning the care-of address to the interface 300, the binding determination engine 303 checks whether the prefix 203 further includes a home prefix or not (Step S45). Absence of a home prefix in the prefix 203 implies that the access router with which the MN 11 associates does not have a routing path to the home MAP 1000 of the MN 11. Thus, in this case, the binding determination engine 303 triggers the binding message creation unit 302 and instructs to update the home MAP 1000 regarding the location of the MN 11 (Step S46) and then finishes this processing (Step S47).

On the other hand, when the prefix 203 includes a home prefix at Step S45, the binding determination engine 303 does not trigger the binding message creation unit 302, and finishes this processing (Step S47). This means that the MN 11 is currently located in the foreign network domain 101 having the roaming contract relationship 10, and since the foreign MAP 1010 has already established the routing path to the home MAP 1000 of the MN 11, it is not necessary to update the home MAP 1000 regarding the location of the MN 11. Note here that the creation of the address at S44 may follow Step S45. In this case, when the home prefix is included at Step 545, the address created is dealt with as an address for local breakout. On the other hand, when the home prefix is not included, the address created is dealt with not only as an address for local breakout but also as CoA. In this way, when the MN 11 moves to a roaming destination, a comparison is made between the prefix notified at the roaming destination and the prefix used at the home network, and determination is made as to whether a connection has to be configured with the MAP 1000 in the home network, thus eliminating transmission of unnecessary signaling.

<Differences from Conventional Techniques>

The following describes differences between the present embodiment and conventional techniques in more detail. In the present embodiment, when the MN 11 acquires network information 20 from the foreign AR 1011 in FIG. 1, the MN 11 knows two prefixes of a home prefix and a foreign prefix from the network information 20. The home prefix is a prefix assigned to the MN 11 from the home network domain 100. The routing of the home prefix is dealt with by the home MAP 1000 that is an anchor point of the home network domain 100. Similarly, the foreign prefix is a prefix assigned from the foreign network domain 101 so that the MN 11 can use. The routing of the foreign prefix is dealt with by the foreign MAP 1010 that is an anchor point of the foreign network domain 101. The MN 11 configures a care-of address (MN11.CoA) from the foreign prefix.

Herein, since the home prefix exists in the network information 20, the MN 11 understands that the foreign AR 1011 has already transmitted a proxy BU message to the home MAP 1000. Thus, the MN 11 knows a routing path set up between the foreign AR 1011 and the home MAP 1000, and understands that there is no need to transmit a BU message notifying of the MN 11 currently being located under the control of the foreign AR 1011.

In this way, it would be obvious for those skilled in the art that a method updating the home MAP 1000 by the MN 11 is different from a method described in Patent Document 2. Patent Document 2 describes an access router carrying out a task to update a home MAP of a MN. This means that the access router transmits, for the MN, a BU message to the home MAP of the MN. Since the access router can omit this task, it is possible for the access router to stop the transmission of a BU message from the initial position. This implies that the access router operates as a binding determination mechanism as in the present embodiment. In this case, the home MAP of the MN does not receive doubly a message indicating of the MN position. However, Patent Document 2 does not describe such a determination mechanism. Therefore, there is a difference between the present embodiment and the conventional technique.

<Message Sequence>

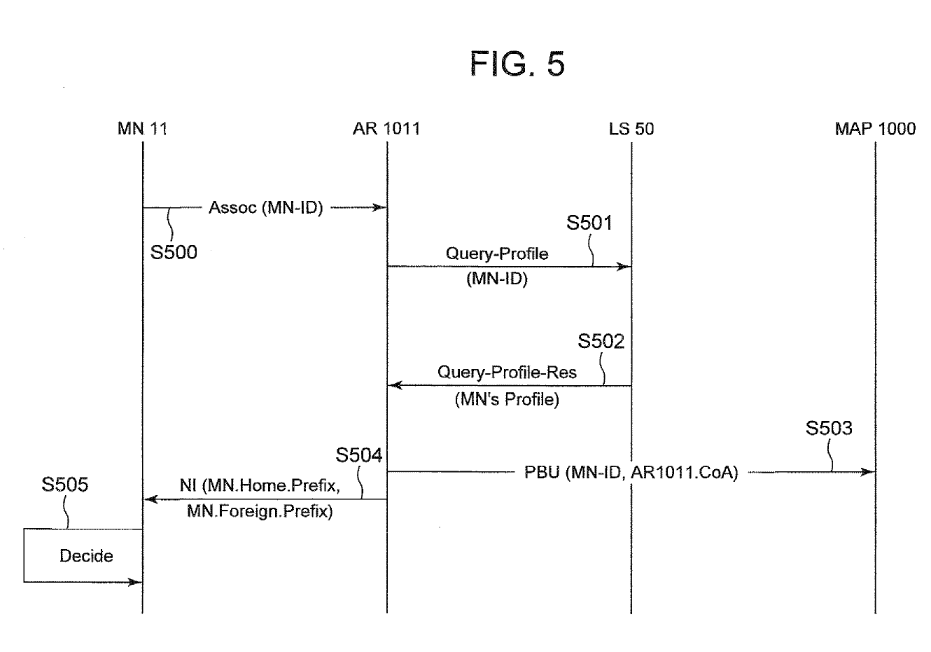

FIG. 5 illustrates a message sequence of the present embodiment.

Step S500: Assoc (MN-ID)

Firstly, the MN 11 associates with the AR 1011 in the foreign network domain 101, and presents an identifier (MN-ID) to the AR 1011 as a part of an access authentication procedure. The MN 11 presents the identifier (MN-ID) to the AR 1011 so as to let the AR 1011 extract policy of the MN 11 from a local server (LS) 50.

Step S501: Query-Profile (MN-ID)

Thus, the AR 1011 makes a query about a policy profile related to the identifier (MN-ID) to the LS 50.

Step S502: Query-Profile-Res (MN'Profile)

Subsequently, the LS 50 returns, as a response, the policy profile related to the identifier (MN-ID) to the AR 1011. In a preferable embodiment, the policy profile of the MN 11 includes: a prefix (MN.Home.Prefix) used in the home network domain 100; a prefix (MN.Foreign.Prefix) used in the foreign network domain 101; and an IP address of the home MAP 1000.

Step S503: PBU (MN-ID, AR1011.CoA)

Subsequently, based on the information obtained from this policy profile of the MN 11, the AR 1011 can transmit a proxy BU message to the home MAP 1000 so as to update a routing state in the home MAP 1000. This updating allows the home MAP 1000 to route a packet addressed to the MN 11 via the AR 1011.

Step S504: NI (MN.Home.Prefix, MN.Foreign.Prefix)

Subsequently, the AR 1011 transmits the network information 20 to the MN 11 at the same time, and provides information on a network with which the MN 11 is currently connected. If possible, the network information 20 includes a home prefix (MN.Home.Prefix) and a foreign prefix (MN.Foreign.Prefix).

Step S505: Decide

Subsequently, when receiving the network information 20, the MN 11 can determine whether or not to transmit a BU message to the home MAP 1000. Herein, the BU message is transmitted so as to update the current location in the home MAP 1000 and let a packet addressed to the MN 11 route to the home MAP 1000. The determination processing by the MN 11 at Step S505 is based on the method described referring to FIG. 4. In this case, since the network information 20 includes a home prefix (MN.Home.Prefix) and a foreign prefix (MN.Foreign.Prefix), the MN 11 understands that the AR 1011 has already updated the home MAP 1000 regarding the current location.

### Embodiment 2

In Embodiment 2, the MN 11 transmits a message to the AR 1011 notifying so as not to advertise a home prefix (MN.Home.Prefix) of the MN 11 that the MN 11 does not use. This message in Embodiment 2 is referred to as a prefix assignment message. This prefix assignment message makes the AR 1011 understand that the MN 11 does not want a network-based mobility management function.

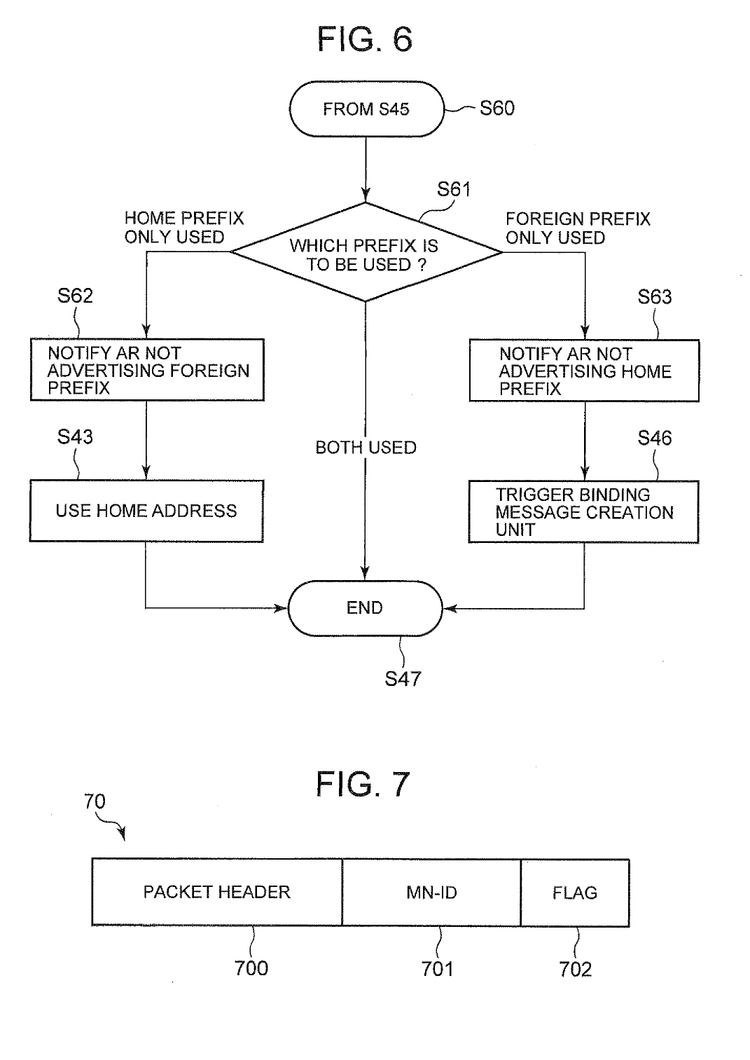

FIG. 6 illustrates a binding determination processing by the MN 11 in Embodiment 2. Step S60 starts when the binding determination engine 303 detects that both of the home prefix (MN.Home.Prefix) and the foreign prefix (MN.Foreign.Prefix) are advertised in the prefix 203 of the network information 20 at Step S45 of FIG. 4 (Yes at Step S45). Firstly, at Step S61, the binding determination engine 303 determines whether the MN 11 tries to use both of the home prefix (MN.Home.Prefix) and the foreign prefix (MN.Foreign.Prefix) or not. This determination is preferably made based on the policy in the MN 11 specifying the prefix usage.

If it is determined so that both prefixes are used, the binding determination engine 303 does not start the binding message creation unit 302, and finishes this processing (Step S47). This means that since the AR 11 has already established a routing path to the home MAP 1000 of the MN 11, there is no need for the MN 11 to notify the home MAP 1000 of the current location. Herein, in the case where there is a possibility that both of the home prefix and the foreign prefix are advertised from the foreign network, the MN 11 may transmit a prefix assignment message during the attach procedure carried out for the connection with the foreign network. Further, during the attach procedure carried out for the connection with the home network, the prefix assignment message may be transmitted and a prefix used in the foreign network may be determined beforehand.

On the other hand, when it is determined at Step S61 that “using a home prefix only”, the binding determination engine 303 understands that the MN 11 does not want to use a foreign prefix, and instructs the binding message creation unit 302 to transmit a prefix assignment message notifying the AR 1011 that the next network information 20 for the MN 11 does not include a foreign prefix (Step S62). This prefix assignment message allows the AR 1011 to know that the MN11 does not require another prefix when the MN 11 is located in the foreign network domain 101, so that the size of the message for a notification of a prefix can be reduced. Next, the home address is assigned for use to the interface 300 (Step S43), and then this processing is finished (Step S47).

When it is determined at Step S61 that “using a foreign prefix only”, the binding determination engine 303 understands that the MN 11 does not want to use a home prefix, and instructs the binding message creation unit 302 to transmit a prefix assignment message notifying the AR 1011 that the next network information 20 for the MN 11 does not include a home prefix (Step S63). This prefix assignment message allows the AR 1011 to know that the MN11 does not require a local prefix, i.e., the home prefix, when the MN 11 is located in the foreign network domain 101, so that the size of the message for a notification of a prefix can be reduced. Next, the binding determination engine 303 instructs the binding message creation unit 302 to update the home MAP 100 regarding the current location of the MN 11, and then this process is finished (Step S47).

It is evident from FIG. 6 that the MN 11 explicitly notifies the AR 1011 using a prefix assignment message that the MN 11 does not require one of the home prefix and the foreign prefix. An advantage thereof resides in that a packet size of the network information 20 that the AR 1011 advertises to the MN 11 can be reduced. A further advantage resides in that, when the MN 11 wants to use a home prefix only, there is no need for the foreign network domain 101 to make a reservation for another prefix from a prefix storage unit of the MN 11. Thus, this prefix can be assigned to another mobile node requiring such a prefix.

FIG. 7 illustrates a format of a prefix assignment message 70 in Embodiment 2 made up of: a packet header 700; a mobile node identifier (MN-ID) 701; and a flag 702. The packet header 700 transmits: a message sender as an IPv4 address or an IPv6 address; a message type field; and a message length field. The MN-ID 701 enables an access router to identify which mobile node transmits the message 70.

The flag 702 enables the mobile node to notify which prefix the access router has to advertise. The flag 702 is a new mobility option, and is represented in two bits in the message 70. For instance, ‘10’ represents that the mobile node wants advertisement of a home prefix only, and ‘01’ represents that mobile node wants advertisement of a foreign prefix only. Herein, the prefix assignment message may be transmitted with a route solicitation (RS) message or a neighbor solicitation (NS) message as well as with a beacon of IEEE802.11, layer 2 signaling used in a cellular system such as a 3GPP, signaling exchanged during the attach procedure to a 3GPP network, an information service response message to IEEE802.21, for example. Herein, the UE may transmit a router solicitation message to the AR 1011 so as to receive the router advertisement message including the network information. Herein, a method to designate a prefix requiring the notification from the access router is not limited to the method using the flag 702. For instance, the message 70 may include a prefix itself requiring the advertisement, or identification information on the home network and the foreign network may be used as information that can specify a prefix. Further, both of the information (handover indication) indicating to use a prefix before movement (handover attach) and information (local breakout indication) indicating to use a prefix after movement (local breakout) may be included, or information meaning both of the handover and the local breakout at the same time may be included. For the attach procedure to a 3GPP network, protocol configuration option (PCO) may be used so as to make a notification of the prefix assignment information from the UE (MN) to a P-GW (MAP 1000).

The following describes an operation of Embodiment 2 in more detail. In FIG. 1, when the MN 11 acquires the network information 20 from the AR 1011, the MN 11 knows two prefixes of a home prefix and a foreign prefix. The home prefix is assigned to the MN 11 from the home network domain 100. The routing of the home prefix is dealt with by the home MAP 1000 that is an anchor point of the home network domain 100. Similarly, the foreign prefix is assigned to the MN 11 from the foreign network domain 101 so that the MN 11 uses the prefix. The routing of the foreign prefix is dealt with by the foreign MAP 1010 that is an anchor point of the foreign network domain 101.

(1) Foreign Prefix Only

Assume herein that the MN 11 determines to want a foreign prefix only for a communication while the MN 11 is located in the foreign network domain 101. Thus, the MN 11 configures a care-of address (MN11.CoA) from the foreign prefix. Then, the MN 11 transmits, to the AR 1011, the prefix assignment message 70 with ‘01’ (=wanting an advertisement of a foreign prefix only) set therein as the flag 702. This message 70 allows the AR 1011 to know that the MN 11 does not require the advertisement of a home prefix. Further, since the home prefix is not required, the AR 1011 does not transmit a proxy BU message to the home MAP 1000.

(2) Home Prefix Only

In the case where the MN 11 determines to want a home prefix only for a communication while the MN 11 is located in the foreign network domain 101, the MN 11 transmits, to the AR 1011, the prefix assignment message 70 with ‘10’ (=wanting an advertisement of a home prefix only) set therein as the flag 702. This message 70 allows the AR 1011 to know that the MN 11 determines to use a home prefix only in the foreign network domain 101. Thus, the AR 1011 stops the advertisement of a foreign prefix to the MN 11, and starts the advertisement of a home prefix thereto. Further, the AR 1011 transmits a proxy BU message to the home MAP 1000.

(3) Both of the Prefixes

In the case where the MN 11 determines to want both of a home prefix and a foreign prefix for a communication while the MN 11 is located in the foreign network domain 101, the MN 11 transmits, to the AR 1011, the prefix assignment message 70 with ‘11’ set therein as the flag 702. This message 70 allows the AR 1011 to know that the MN 11 determines to use both of the home prefix and the foreign prefix in the foreign network domain 101. Thus, the AR 1011 advertises both of the prefixes to the MN 11, and transmits a proxy BU message to the home MAP 1000. In this case, since the MN 11 knows that the AR 1011 will transmit a proxy BU message to the home MAP 1000, the MN 11 determines not to transmit a BU message to the home MAP 1000.

### Embodiment 3

In Embodiment 3, the MN 11 transmits a prefix assignment message 70 to the home MAP 1000. This method is effective when the AR 1011 does not understand the message 70 (e.g., in the case of a legacy router). Herein, similarly to Embodiment 2, when there is a possibility that the foreign network advertises both of a home prefix and a foreign prefix in Embodiment 3, the MN 11 may transmit the prefix assignment message 70 to the MAP 1000 during the attach procedure carried out for a connection with the foreign network. Alternatively, the MN 11 may transmit the prefix assignment message 70 during the attach procedure carried out for a connection with the home network, so that a prefix to be used for roaming into a foreign network may be determined beforehand. This leads to an advantage that a preferable prefix can be obtained immediately after the movement. As a method to transmit the prefix assignment message 70, a BU message that the MN 11 transmits to the MAP 1000 or a signaling during the attach procedure performed by the MN 11 for a connection with the home network or the foreign network may be used. Note here in the attach procedure to a 3GPP network, protocol configuration option (PCO) can be used for a notification of prefix assignment information from a UE (MN) to a P-GW (MAP 1000). When the home MAP 1000 understands the intention of the MN 11, the home MAP 1000 notifies the AR 1011 of the intention of the MN 11. The transmission destination of the prefix assignment message 70 may be a LS 50 (in the case of a 3GPP network, HSS/AAA) or the prefix assignment information that the MAP 1000 obtains from the MN 11 may be registered in the LS 50 (HSS/AAA).

Herein, when the AR 1011 is not a legacy router, the home MAP 1000 can notify the AR 1011 of the intention of the MN 11 using the prefix assignment message 70. On the other hand, when the AR 1011 is a legacy router, the home MAP 1000 can transmit, to the AR 1011, updating policy (e.g., updating policy including a foreign prefix only) of the MN 11 representing the intention of the MN 11. This updating policy enables the AR 1011 to know which prefix is to be advertised to the MN 11. Preferably the home MAP 1000 transmits, to the AR 1011, the prefix assignment message 70 or the updating policy together with a proxy BA message as a response to the proxy BU message. Herein, when the LS 50 (HSS/AAA) keeps the latest prefix assignment information notified from the MN 11 or set by an operator, the AR 1011, the MAP 1010, or the LS (HSS/AAA) existing in a network as a roaming destination may make an inquiry for acquisition to the LS 50 (HSS/AAA) existing in the home network of the MN 11 during the attach procedure carried out by the MN 11 for a connection with the network as the roaming destination as illustrated in FIG. 5.

The following describes an operation in Embodiment 3 in more detail. In FIG. 1, when the MN 11 acquires the network information 20 from the AR 1011, the MN 11 knows two prefixes of a home prefix and a foreign prefix. The home prefix is assigned to the MN 11 from the home network domain 100. The routing of the home prefix is dealt with by the home MAP 1000 that is an anchor point of the home network domain 100. Similarly, the foreign prefix is assigned to the MN 11 from the foreign network domain 101 so that the MN 11 uses the prefix. The routing of the foreign prefix is dealt with by the foreign MAP 1010 that is an anchor point of the foreign network domain 101. Further, the MN 11 knows that although the AR 1011 is not a legacy router, the AR 1011 does not process a request of the MN 11 before the authorization by the home MAP 1000.

(1) Foreign Prefix Only

Assume herein that the MN 11 determines to want a foreign prefix only for a communication while the MN 11 is located in the foreign network domain 101. Thus, the MN 11 configures a care-of address (MN11.CoA) from the foreign prefix. Then, since the MN 11 knows that the prefix assignment message 70 is not processed until the AR 1011 is authorized by the home MAP 1000, the MN 11 transmits, to the home MAP 1000, the prefix assignment message 70 with ‘01’ (=wanting an advertisement of a foreign prefix only) set therein as the flag 702. This message 70 allows the home MAP 1000 to know that the MN 11 does not intend to use the home prefix. Herein assume that the home MAP 1000 transfers the prefix assignment message 70 to the AR 1011. Upon receipt of the prefix assignment message 70 from the home MAP 1000, the AR 1011 regards the message 70 to be authorized, and stops advertisement of the home prefix to the MN 11.

The cases of (2) home prefix only and (3) both of the prefixes are substantially similar to those in Embodiment 2, and therefore the descriptions for the same have been omitted.

### Embodiment 4

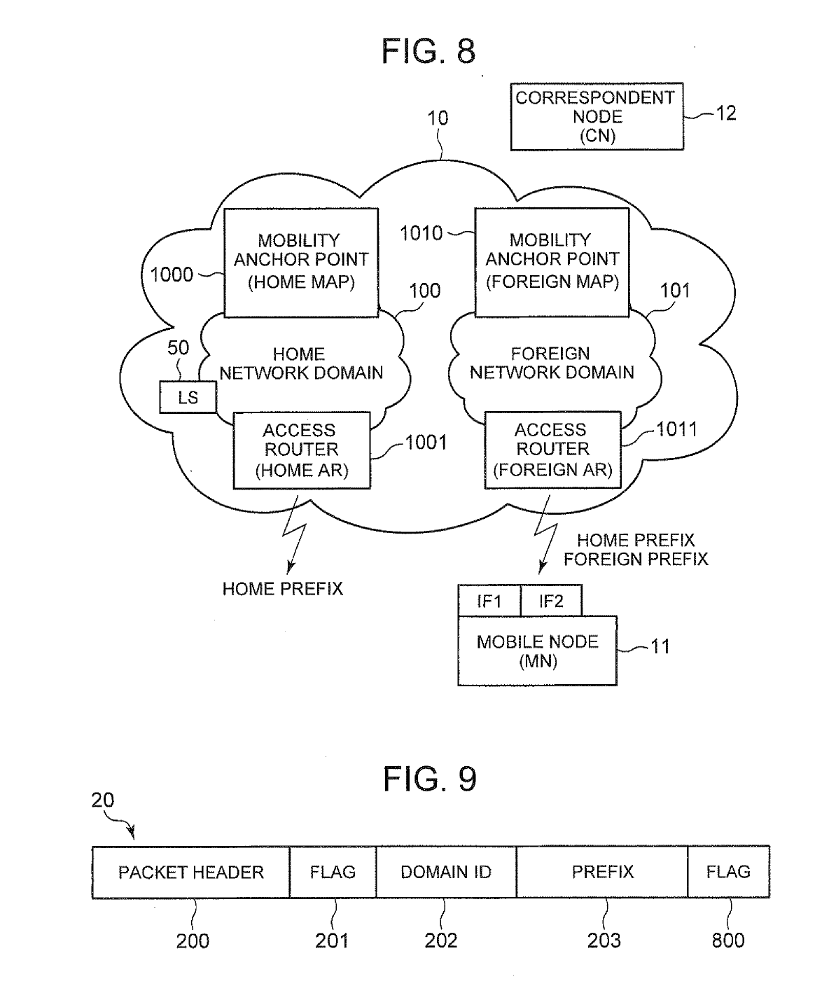

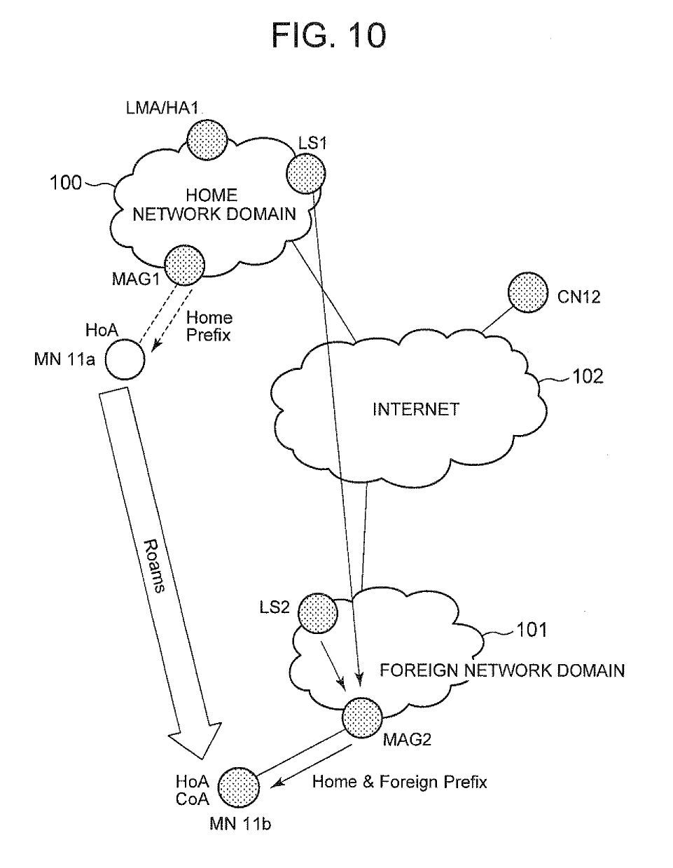

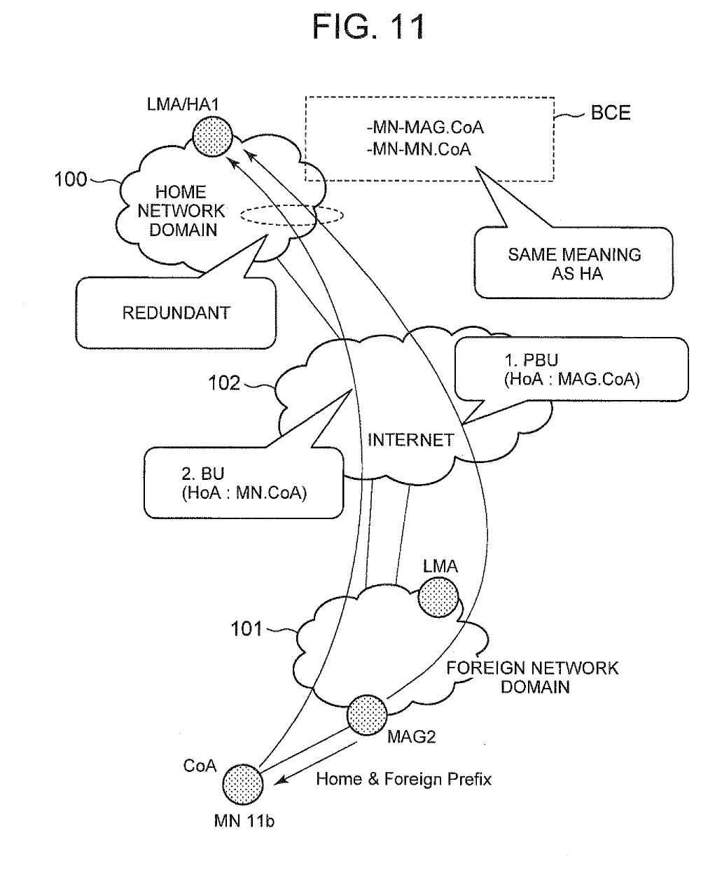

In Embodiment 4, when the MN 11 includes a plurality of interfaces (IF1, IF2) as illustrated in FIG. 8, the MN 11 transmits a prefix assignment message 70 to the home MAP 1000 via IF1 connected with the home MAP 1000. This method is effective when a transmission time of the prefix assignment message 70 via IF1 is extremely short. As another advantage, in order to notify as to which prefix the MN 11 has to advertise to the AR 1011, the IF1 connected with the home MAP 1000 can be used prior to a connection of IF2 of the MN 11 with the AR 1011. Herein, in FIG. 8, when both of the home network domain 100 and the foreign network domain 101 are 3GPP networks, IF2 of the MN 11 doesn't have to be an interface connectable with a 3GPP network, which may be an interface connectable with a non-3GPP network such as a WLAN or WIMAX. In this case, IF2 carries out one of a communication (home routed) conducted from a non-3GPP network that the foreign network domain 101 manages via the home network domain 100 or a communication (local breakout) directly conducted from the foreign network domain 101 or both of them.

The following describes an operation in Embodiment 4 in more detail. In FIG. 8, when the MN 11 acquires network information 20 from the foreign AR 1011 in IF2 in a state where IF1 of the MN 11 is connected with the home AR 1001, the MN 11 knows two prefixes of a home prefix and a foreign prefix. The home prefix is assigned to the MN 11 from the home network domain 100. The routing of the home prefix is dealt with by the home MAP 1000 that is an anchor point of the home network domain 100. Similarly, the foreign prefix is assigned to the MN 11 from the foreign network domain 101 so that the MN 11 uses the prefix. The routing of the foreign prefix is dealt with by the foreign MAP 1010 that is an anchor point of the foreign network domain 101.

(1) Foreign Prefix Only

Assume herein that the MN 11 determines to want a foreign prefix only for a communication while the MN 11 is located in the foreign network domain 101. Thus, the MN 11 configures a care-of address (MN11.CoA) from the foreign prefix. Then, since the MN 11 currently includes IF1 connected with the home network domain 100, the MN 11 transmits, to the home MAP 1000, the prefix assignment message 70 with ‘01’ (=wanting an advertisement of a foreign prefix only) set therein as the flag 702 via IF1. Thus, similarly to Embodiment 3, this message 70 allows the home MAP 1000 to know that the MN 11 does not intend to use the home prefix. In this case, the home MAP 1000 transfers the prefix assignment message 70 to the AR 1011. Upon receipt of the prefix assignment message 70 from the home MAP 1000, the AR 1011 regards the message 70 to be authorized, and stops advertisement of the home prefix to the MN 11.

The cases of (2) home prefix only and (3) both of the prefixes are substantially similar to those in Embodiment 3, and therefore the descriptions for the same have been omitted.

### Embodiment 5

In Embodiment 5, the foreign AR 1011 is equipped with an intelligent function added thereto. In this case, the AR 1011 includes a binding determination engine 303 illustrated in FIG. 3. When the AR 1011 extracts a policy profile of the MN 11, the binding determination engine 303 knows that the MN 11 is about to transmit a BU message to the home MAP 1000. Thus, the binding determination engine 303 stops providing a network-based mobility management function to the MN 11, and makes the MN 11 update the home MAP 1000. The purpose of this processing is to realize a similar advantage even when the MN 11 is legacy and is not equipped with the binding determination engine 303.

The following describes an operation in Embodiment 5 in more detail. In FIG. 1, when the AR 1011 acquires a policy profile of the MN 11 from the local server 50, the AR 1011 makes the binding determination engine 303 determine that the MN 11 tries to configure a care-of address of an interface 300 associating with the AR 1011. Thus, the AR 1011 does not transmit, to the home MAP 1000, a proxy BU message to update the location of the MN 11. Similarly, the network information 20 advertised to the MN 11 includes ‘0’ (=not supporting a network-based mobility function) as a network-based mobility support flag 210, the ID of the foreign network domain 101 as a domain ID 202, and a foreign prefix only as a prefix 203. Based on this network information 20, the MN 11 transmits a BU message to the home MAP 1000, so that the current location of the MN 11 in the home MAP 1000 can be updated.

### Embodiment 6

In Embodiment 6, the foreign AR 1011 is equipped with, as an intelligent function, a function to notify the MN 11 that the home MAP 1000 has been already notified of the existence of the foreign prefix. Thus, the AR 1011 transmits a proxy BU message to a home MAP 100 to make a notification of a foreign prefix that the MN 11 can obtain. Further, the AR 1011 notifies the MN 11 that the home MAP 1000 is updated with this notification. Preferably, this notification can be transmitted with network information 20 advertised to the MN 11.

This notification allows the foreign AR 1011 to notify the MN 11 that the there is no need to transmit a BU message to the home MAP 1000. As a result, the foreign AR 1011 refreshes a foreign prefix in the home MAP 1000. This leads to an advantage that when the home MAP 1000 cannot route a packet to the foreign AR 1011, the home MAP 1000 can perform the routing to the foreign MAP 1010. As an example, there is a case where the MN 11 performs roaming from a foreign AR 1011 having a roaming contract relationship 20 to another AR (not illustrated). In this case, when the home MAP 1000 does not know a new AR yet, a packet can be temporarily routed to the foreign MAP 1010 where the MN 11 is known to be currently located.

FIG. 9 illustrates network information 20 in Embodiment 6, and this network information 20 includes a flag 800 in addition to the fields of FIG. 2, the flag 800 allowing the AR 1011 to notify the MN 11 that the home MAP 100 is updated for the foreign prefix. The flag 800 may be one bit where ‘1’ indicates “notifying the home MAP 100 of a foreign prefix” and ‘0’ indicates “not notifying the home MAP 100 of a foreign prefix”. Since the flag 800=1, the MN 11 can know that there is no need to notify the home MAP 1000 of a BU message.

The following describes an operation in Embodiment 6 in more detail. In FIG. 1, the foreign AR 1011 transmits a proxy BU message to the home MAP 1000 so as to notify that the MN 11 associates with the foreign AR 1011. This proxy BU message further includes a foreign prefix of the foreign MAP 1010 that the MN 11 uses. Thus, the home MAP 1000 understands that a packet addressed to the MN 11 can be routed to both of the foreign AR 1011 and the foreign MAP 1010. Herein, the foreign MAP 1010 transfers a packet addressed to itself to the foreign AR 1011. Further, the foreign AR 1011 advertises, to the MN 11, network information 20 with ‘1’ (=home MAP 100 being notified) set therein as the flag 800. This advertisement allows the MN 11 to know that the foreign AR 1011 notifies the home MAP 1000 of the foreign prefix. Thus, the MN 11 does not transmit a BU message to the home MAP 1000.

When the MN 11 roams into a new access router (foreign AR 1011) in the foreign network domain 101, the foreign AR 1011 tries to update both of the MAPs 1000 and 1010 with a new position. Assume herein that the proxy BU message does not reach the home MAP 1000. The reason therefor is that a packet is lost during the transmission. When the home MAP 1000 is updated so that the MN 11 is no longer located in the AR 1011, the home MAP 1000 does not have a path to route a packet addressed to the MN 11 unless the home MAP 1000 knows a foreign prefix. This suggests that when the MN 11 reestablishes a routing path to the home MAP 1000, the MN 11 will know the packet loss.

According to this Embodiment 6, the home MAP 1000 can know an alternative path via the foreign MAP 1010. Thus, the home MAP 1000 routes a packet to the foreign MAP 1010 in the expectation that the foreign MAP 1010 knows the current location of the MN 11. In this case, the foreign MAP 1010 understands that the MN 11 associates with the AR 1011, and then routes the packet.

### Embodiment 7

In Embodiment 7, the foreign AR 1011 does not notify, as an intelligent function, the MN 11 that a foreign prefix is available. When the foreign AR 1011 knows that the MN 11 is legacy and that a network-based mobility management function and a host-based mobility management function of the MN 11 are mutually independently equipped, the foreign AR 1011 does not advertise a foreign prefix, whereby the MN 11 may be prevented from triggering the host-based mobility management function. Thereby, the MN 11 stops transmitting a BU message to the home MAP 1000.

That is a description of the present invention by way of the embodiments. However, it would be obvious for those skilled in the art that the present invention can be modified variously without departing from the scope of the present invention. For instance, the present invention is applicable to a MN having a plurality of interfaces and actively connecting with a foreign network domain not having a roaming contract relationship 10. When a BU message is transmitted to a home MAP 1000 for bulk registration of all care-of addresses using the interfaces, for example, this MN can exclude a care-of address used in the foreign network domain 101 having the roaming contract relationship 10. In this case, the binding determination engine 303 enables the MN to know the care-of address used in the foreign network domain 101 having the roaming contract relationship 10.

In the above-stated embodiments, the prefix assignment message 70 is transmitted to the home MAP 1000 or the AR 1011. However, it would be obvious for those skilled in the art that the message 70 can be transmitted to any entity located in the home network domain 100 or the foreign network domain 101. It would be further obvious for those skilled in the art that the MN 11 can transmit the message 70 to the AR during the access authentication phase. This message 70 preferably is transmitted during the exchange of an authentication authorization and accounting (AAA) message. Further, the above embodiments describe the case where the registration message omitted is a BU message that the MN 11 transmits to the home MAP 1000. Instead, a PBU message that the foreign AR 1011 transmits to the home MAP 1000 may be omitted.

The respective functional blocks used for the above description of embodiments can be typically implemented by a Large Scale Integration (LSI) as an integrated circuit. They may be individually made into one chip, or may be made into one chip so as to include a part or the whole thereof. The LSI referred to herein may be called an Integrated Circuit (IC), a system LSI, a super LSI, or an ultra LSI depending on the degree of integration. The technique for implementing the integrated circuit is not limited to LSI, but may be implemented by a dedicated circuit or a general-purpose processor. Also, a Field Programmable Gate Array (FPGA) enabling programming after the LSI fabrication, or a re-configurable processor that can be reconfigured concerning the connection and configuration of a circuit cell within a LSI may be used. Moreover, if any technique is developed that can replace the LSI by the development in semiconductor technology or using derivative different techniques, the functional blocks can be naturally integrated using such techniques. For instance, biotechnology may be applied thereto.

### INDUSTRIAL APPLICABILITY

The present invention has an advantage that when a mobile node roams into a foreign network domain having a roaming relationship with a home network domain, the number of messages to register position information of the mobile node with a home agent can be reduced, and is applicable to a proxy mobile Internet protocol.

1. A communication method when a mobile node roams into a foreign network domain from a home network domain, the communication method comprising:
a step conducted by the foreign network domain of transmitting a foreign prefix as a prefix of the foreign network domain, and when the foreign network domain has a roaming contract relationship with the home network domain, of transmitting a home prefix as a prefix of the home network domain; and
a step conducted by the mobile node of receiving the foreign prefix from the foreign network domain and creating, from the foreign prefix, a care-of address to be used in the foreign network domain, while determining whether the home prefix is received or not from the foreign network domain, when the home prefix is not received, transmitting a registration message to a home agent of the home network domain, the registration message registering the created care-of address, and when the home prefix is received, not transmitting the registration message.

2. A communication system when a mobile node roams into a foreign network domain from a home network domain, the communication system comprising:
a unit configured to make the foreign network domain transmit a foreign prefix as a prefix of the foreign network domain, and when the foreign network domain has a roaming contract relationship with the home network domain, transmit a home prefix as a prefix of the home network domain; and
a unit configured to make the mobile node receive the foreign prefix from the foreign network domain and create, from the foreign prefix, a care-of address to be used in the foreign network domain, while making the mobile node determine whether the home prefix is received or not from the foreign network domain, when the home prefix is not received, transmit a registration message to a home agent of the home network domain, the registration message registering the created care-of address, and when the home prefix is received, not transmit the registration message.

3. A mobile node in a communication system when the mobile node roams into a foreign network domain from a home network domain, the mobile node comprising:
a unit configured to receive a foreign prefix as a prefix of the foreign network domain transmitted from the foreign network domain, while receiving a home prefix as a prefix of the home network domain transmitted when the foreign network domain has a roaming contract relationship with the home network domain;
a unit configured to create a care-of address to be used in the foreign network domain from the foreign prefix received from the foreign network domain; and
a binding determination unit configured to determine whether the home prefix is received or not from the foreign network domain, when the home prefix is not received, transmits a registration message to a home agent of the home network domain, the registration message registering the created care-of address, and when the home prefix is received, does not transmit the registration message to the home agent.

4. The mobile node according to claim 3, wherein when both of the foreign prefix and the home prefix advertised from an access router of the foreign network domain are received, and when the foreign prefix only is to be used, the binding determination unit notifies the access router of not advertising the home prefix and transmits the registration message to the home agent, and when the home prefix only is to be used, the binding determination unit notifies the access router of not advertising the foreign prefix and does not transmit the registration message to the home agent.

5. The mobile node according to claim 4, wherein the binding determination unit transmits, to a home agent of the foreign network domain, a message to be notified to the access router of the foreign network domain and makes the home agent of the foreign network domain notify the access router of the message.

6. The mobile node according to claim 4 further comprising: a first interface for a connection with the access router of the foreign network domain; and a second interface for a connection with an access router of the home network domain, wherein
the binding determination unit transmits a message to be notified to the access router of the foreign network domain to the home agent of the home network domain via the second interface so as to make the home agent of the home network domain notify the access router of the message.

7. A communication method when a mobile node roams into a foreign network domain from a home network domain, the communication method comprising:
a step conducted by an access router of the foreign network domain of transmitting a foreign prefix as a prefix of the foreign network domain, and when the foreign network domain has a roaming contract relationship with the home network domain, of transmitting a home prefix as a prefix of the home network domain; and
a step conducted by the access router of the foreign network domain of determining which prefix of the foreign prefix and the home prefix the mobile node uses, when the foreign prefix only is to be used, stopping transmission of the home prefix, and when the home prefix only is to be used, stopping transmission of the foreign prefix.

8. A communication system when a mobile node roams into a foreign network domain from a home network domain, the communication system comprising:
a unit configured to make an access router of the foreign network domain transmit a foreign prefix as a prefix of the foreign network domain, and when the foreign network domain has a roaming contract relationship with the home network domain, transmit a home prefix as a prefix of the home network domain; and
a unit configured to make the access router of the foreign network domain determine which prefix of the foreign prefix and the home prefix the mobile node uses, when the foreign prefix only is to be used, stop transmission of the home prefix, and when the home prefix only is to be used, stop transmission of the foreign prefix.

9. An access router in a foreign network domain when a mobile node roams into the foreign network domain from a home network domain, the access router comprising:
a unit configured to transmit a foreign prefix as a prefix of the foreign network domain, and when the foreign network domain has a roaming contract relationship with the home network domain, transmits a home prefix as a prefix of the home network domain; and
a unit configured to determine which prefix of the foreign prefix and the home prefix the mobile node uses, when the foreign prefix only is to be used, stops transmission of the home prefix, and when the home prefix only is to be used, stops transmission of the foreign prefix.

10. A communication method when a mobile node roams into a foreign network domain from a home network domain, the communication method comprising:
a step conducted by an access router of the foreign network domain of transmitting a foreign prefix as a prefix of the foreign network domain, and when the foreign network domain has a roaming contract relationship with the home network domain, of transmitting a home prefix as a prefix of the home network domain; and
a step conducted by the access router of the foreign network domain of determining whether the mobile node uses or not the foreign prefix, and when the foreign prefix is to be used, notifying the mobile node that a registration message is not transmitted to a home agent of the home network domain, the registration message registering the created care-of address.

11. A communication system when a mobile node roams into a foreign network domain from a home network domain, the communication system comprising:
a unit configured to make an access router of the foreign network domain transmit a foreign prefix as a prefix of the foreign network domain, and when the foreign network domain has a roaming contract relationship with the home network domain, transmit a home prefix as a prefix of the home network domain; and
a unit configured to make the access router of the foreign network domain determine whether the mobile node uses or not the foreign prefix, and when the foreign prefix is to be used, notify the mobile node that a registration message is not transmitted to a home agent of the home network domain, the registration message registering the created care-of address.

12. An access router in a foreign network domain when a mobile node roams into the foreign network domain from a home network domain, the access router comprising:
a unit configured to transmit a foreign prefix as a prefix of the foreign network domain, and when the foreign network domain has a roaming contract relationship with the home network domain, transmits a home prefix as a prefix of the home network domain; and
a unit configured to determine whether the mobile node uses or not the foreign prefix, and when the foreign prefix is to be used, notifies the mobile node that a registration message is not transmitted to a home agent of the home network domain, the registration message registering the created care-of address.
